(19) United States
(12) Patent Application Publication
(10) Pub. No.: US 2010/0312618 A1
(43) Pub. Date: Dec. 9, 2010

(54) Transaction System for Use in Authorising Cashless Transactions

(75) Inventors: David Ramsdale, Victoria (AU); Robert Dennett, New South Wales (AU); Gino Dompietro, Victoria (AU)

Correspondence Address: SUTHERLAND ASBILL & BRENNAN LLP, 999 PEACHTREE STREET, N.E., ATLANTA, GA, 30309, US

(73) Assignees: THE COCA-COLA COMPANY, Atlanta, GA (US); TRANSURBAN LIMITED, Victoria (AU)

(21) Appl. No.: 12/519,199

(22) PCT Filed: Dec. 19, 2006
(86) PCT No.: PCT/AU06/01931

§ 371 Date: Feb. 15, 2010

(51) Int. Cl. G06Q 20/00; G06Q 40/00; G06Q 50/00; G06F 17/00

(52) U.S. Cl. 705/13; 705/44; 235/382

(57) ABSTRACT

A transaction system, including: an entry system for reading first identification data from a first device and second identification data from a second device; and a database system for accessing payment account data of a transaction account on the basis of the first and second identification data, and requesting authorisation data for a payment transaction using the payment account data. The entry system performs an authorisation process in response to the authorisation data being received. The database system stores an authorisation record with an authorisation time in response to the authorisation data being received. A payment system can be used to read the second identification data from the second device and generate payment data representing a payment amount. The database system then determines authorisation for a payment transaction on the basis of the second identification data and the authorisation record, and in response submits the payment data and the payment account data to a payment processing system for performing the payment transaction.

### FIELD

The present invention relates to a transaction system, and processes performed by the system. The system is for use in authorising a cashless transaction.

### BACKGROUND

Many different cashless transaction systems have been developed or proposed, with only a limited number being successfully implemented and used. The systems usually need to meet a number of competing criteria for the various parties associated with monetary transactions. The criteria, and technical requirements and definitions, need to be addressed to allow the system to be convenient and easy to use for consumers, and also meet security and privacy concerns of consumers, merchants, account issuers, and transaction acquirers.

For example, a cashless transaction system has been proposed that uses a radio frequency identification device (RFID) carried by a consumer or mounted on a consumer's vehicle. The RFID is read by the system to provide identification data used to identify a previously established payment account. The RFID is directly associated with the payment account from which payment is directly made for goods or services. Once the payment account and associated RFID have been verified, payment can be made at the time of purchase by the consumer providing additional identification data that is associated with the RFID, such as the entry of a PIN or scanning of a barcode provided by the consumer. The system does not, however, determine if sufficient funds are in the payment account until a payment is requested and the earlier verification is only performed on the basis of the first identification data held by the RFID. The system also needs to include infrastructure to handle payments from the account and provide facilities to ensure any sufficient funds are available, such as enabling funds to be added to a debit payment account. The ease of use for the consumer is also compromised if the consumer needs to remember the second identification data, such as a PIN. Yet without the correlation of two forms of identifying data, the security of the system is compromised.

Accordingly, it is desired to provide a technical solution to address the above or at least provide a useful alternative.

### SUMMARY

In accordance with the present invention there is provided a transaction system, including:
an entry system for reading first identification data from a first device and second identification data from a second device; and
a database system for accessing payment account data of a transaction account on the basis of said first and second identification data, and requesting authorisation data for a payment transaction using said payment account data;
said entry system performing an authorisation process in response to said authorisation data being received.

Preferably said database system stores an authorisation record with an authorisation time in response to said authorisation data being received.

Preferably the system further includes a payment system for reading said second identification data from said second device and generating payment data representing a payment amount; said database system determining authorisation for a payment transaction on the basis of said second identification data and said authorisation record, and in response submitting said payment data and said payment account data to a payment processing system for performing said payment transaction.

The present invention also provides a transaction process including:
reading first identification data from a first device and second identification data from a second device;
accessing a transaction account on the basis of said first and second identification data;
requesting authorisation data for a payment transaction using payment account data of said transaction account; and
storing an authorisation record with an authorisation time in response to said authorisation data being received.

Preferably the process further includes validating said first and second devices using said first and second identification data.

Advantageously, the transaction process may further include:
reading said second identification data from said second device and generating payment data representing a payment amount;
determining authorisation for a payment transaction on the basis of said second identification data and said authorisation record, and
submitting said payment data and said payment account data to a payment processing system for performing said payment transaction.

The present invention also provides a transaction process, including:
reading and validating a first RFID;
reading and validating a second RFID;
accessing payment account data associated with said first RFID and said second RFID; and
submitting an authorisation transaction with said payment account data to a payment processing system to obtain authorisation data representing approval for subsequent use of said second RFID, within a predetermined period of time, to authorise a payment.

### BRIEF DESCRIPTION OF THE DRAWINGS

Preferred embodiments of the present invention are hereinafter described, by way of example only, with reference to the accompanying drawings, wherein:

FIG. 1 is a block diagram of a preferred embodiment of a transaction system;

FIG. 2 is a schematic diagram of an entry system of the transaction system;

FIG. 3 is a block diagram of central server and site components of the transaction system;

FIG. 4 is a flow diagram of a transaction account establishment process performed by web and database servers of the transaction system;

FIG. 5 is a flow diagram of an entry process performed by an entry controller of the transaction system; and

FIG. 6 is a payment process performed by a payment controller of the transaction system.

### DESCRIPTION OF PREFERRED EMBODIMENTS

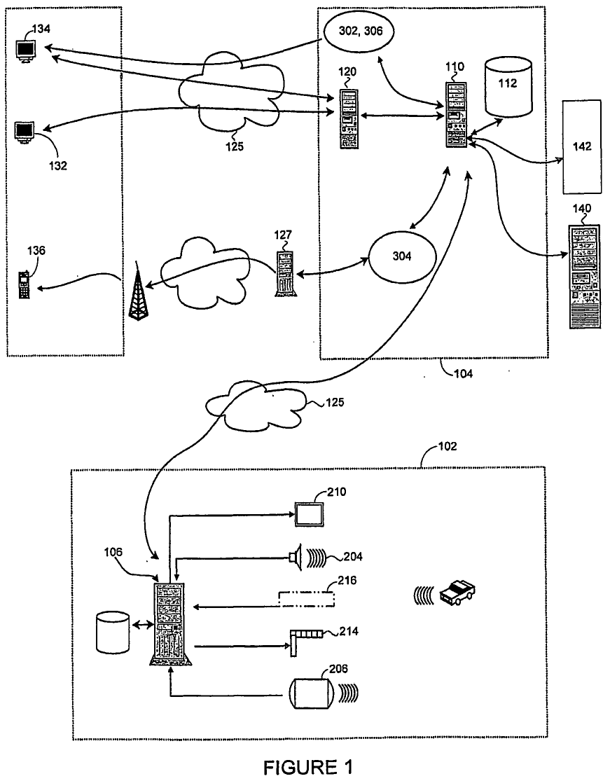

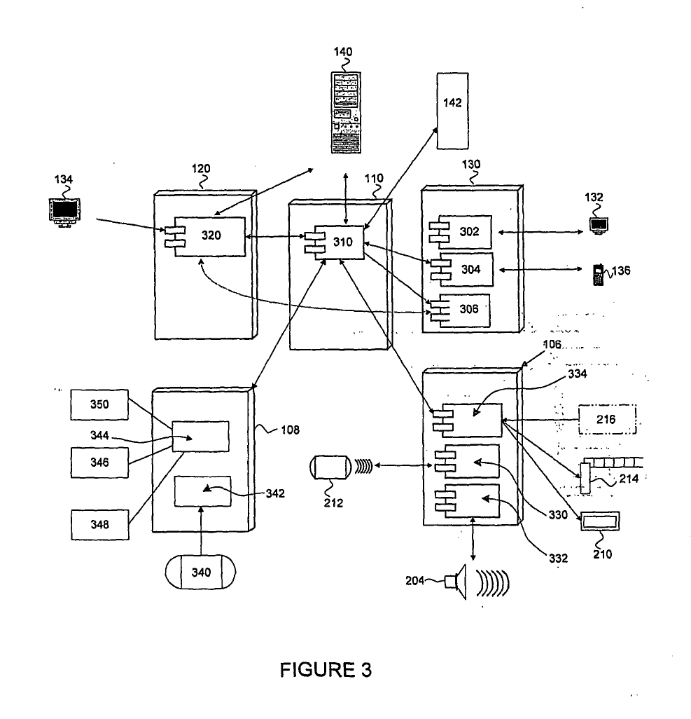

A transaction system, as shown in FIGS. 1 and 3, is used to facilitate cashless transactions by performing dual authorisation processes using identification data from two, radio frequency identification devices (RFIDs). The transaction system includes a site system 102 and a central or back office system 104 that is able to communicate with a number of site systems 102 using a broadband data communications network 130 (for example using the Internet protocols over a DSL network). The site system 102 is located at a site that offers products, i.e. goods or services, for purchase by consumers. For example, the site may be a supermarket, shopping centre, parking lot, restaurant, etc.

The central system 104 includes a web server 120, database server 110, and a messaging server 130. The messaging server 130, as shown in FIG. 3, includes an email subsystem 302, an SMS subsystem 304 and a report generator 306.

The database server 110 includes a computer server, such as that produced by Lenovo Group Ltd. or Apple Computer Inc., running database server computer software, such as MySQL, on an operating system, such as a Windows Server or Linux. The database server 110 maintains transaction account data, described below, for users of the transaction system in a central database 112. The database server 110 also includes a communications controller 310 for handling receipt, transmission, and processing of control data passed between other components of the transaction system. The communications controller 310 includes a communications module and standard communications interface components, such as a DSL modem. The module may be written in computer program code, such as C++ or Java, or implemented by dedicated hardware circuits, eg ASICs and FPGAs. The database server 110 is able to communicate with a payment processing system (PPS) 140 and a tolling system 142. The PPS 140 may be maintained by one or more financial institutions and includes electronic funds transfer systems for performing credit or debit card transactions. For example, the PPS 140 may include an existing electronic funds transfer at point of sale (EFTPOS) network. The tolling system 142 includes a database server for maintaining tolling account data for users of the tolling system 142, which may be a traffic tolling system such as that produced by Kapsch TrafficCom Ab of Sweden. The tolling database server 142 is able to access the tolling account data of a user, which includes data associated with a first RFID 230 used by the transaction system, as described below.

The web server 120 includes a server computer, such as that produced by Lenovo Group Ltd. or Apple Computer Inc., running web server code, such as Apache, and Java Server Pages (JSP) and Java Servlets on an operating system, such as Windows Server or Linux. The web server 120 supports a website 320, as described below, and enables the remote establishment and maintenance of transaction accounts maintained by the database server 110. The website of the web server 120 can be accessed over the Internet 125 by a client computer 132 of a user (e.g. consumer) or a client computer 134 of an administrator.

The email subsystem 302 includes an SMTP server for sending email messages to client systems 132 and 134 on the basis of instruction messages received from the database server 110 or the report generator 306. The report generator 306 is able to generate reports as requested or on a regular basis using data accessed from the database 112. The reports can then be attached to messages generated and sent by the email subsystem 302. The reports can be requested by an administrator 134 accessing the website 320. On instructions from the database server 110, the SMS subsystem 304 is also able to generate SMS messages to be sent by an SMS gateway 127 to a mobile cellular phone 136 of a user.

The web server 120 and the messaging server 130 support communications services, as described below, for the systems or devices, 132, 134 and 136 of administrators and users of the transaction system.

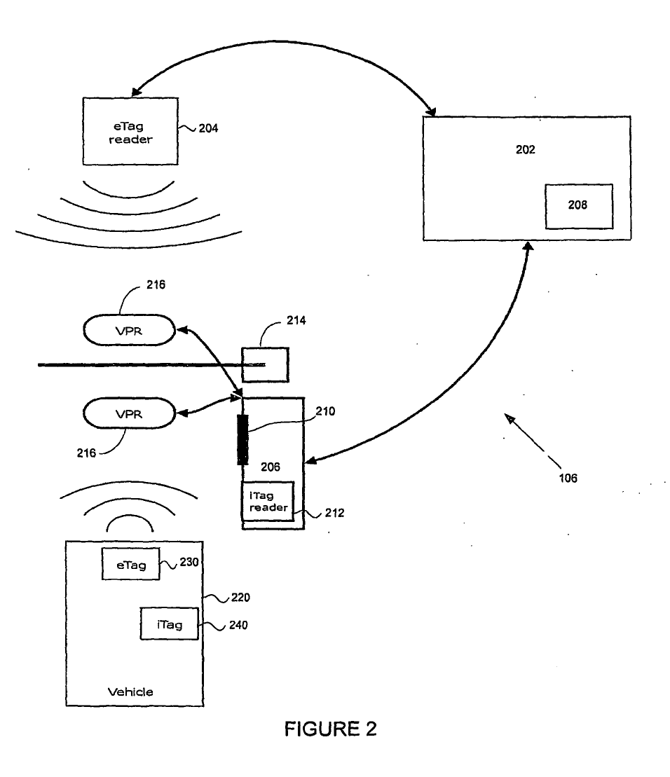

A site system 102 includes one or more entry control systems 106, as shown in FIGS. 1, 2 and 3, and one or more payment systems 108, as shown in FIG. 3. For a site having multiple entry and payment systems, data processing components of the systems may be combined.

An entry system 106, as shown in FIGS. 1, 2 and 3, includes a local computer system 202, a first RFID reader 204 and a boom gate controller 206 both connected to the local computer system 202 by digital input/output communication interface cards 208 for the first reader 204 and gate controller 206. The boom gate controller 206 includes a liquid crystal display 210, a second RFID reader 212, a vehicle boom gate 214 and vehicle presence relays (VPRs) 216 for detecting the presence of a vehicle 220. The vehicle 220 includes a first RFID device 230, herein referred to as an “eTag”, and a second RFID device 240, herein referred to as an “iTag”.

The eTag 230 transmits first identification data to the reader 204, when within range of and queried by the reader 204. The identification data represents a number unique to the eTag. The eTag 230 is associated with the vehicle 220 and a tolling account maintained for a user by the tolling system 142. The eTag 230 may be used to identify the vehicle and the account for the tolling system when the vehicle is driven on a toll road, such as the CityLink network of Transurban Limited. For example, the eTag 230 may be a PREMID microwave link device produced by Kapsch TrafficCom Ab. The eTag 230 would normally be mounted in and remain in the associated vehicle 220.

The second RFID tag 240 is a passive short range transponder. The transponder transmits, using a high frequency, second identification data to the iTag reader 212, when placed in close proximity to the reader 212. The second identification data is unique to the iTag 240 and is associated with a transaction account for the use of the iTag 240. The iTag 240 may be the size of a small coin or disc, and can be conveniently distributed and attached to a wallet, cellular phone or key fob. The iTag reader 212 is a device capable of reading the unique identification data of MIFARE compliant RFIDs operating within the HF (13.56 Mhz) range, such as those produced by HID Corporation, Texas Instruments and Phillips.

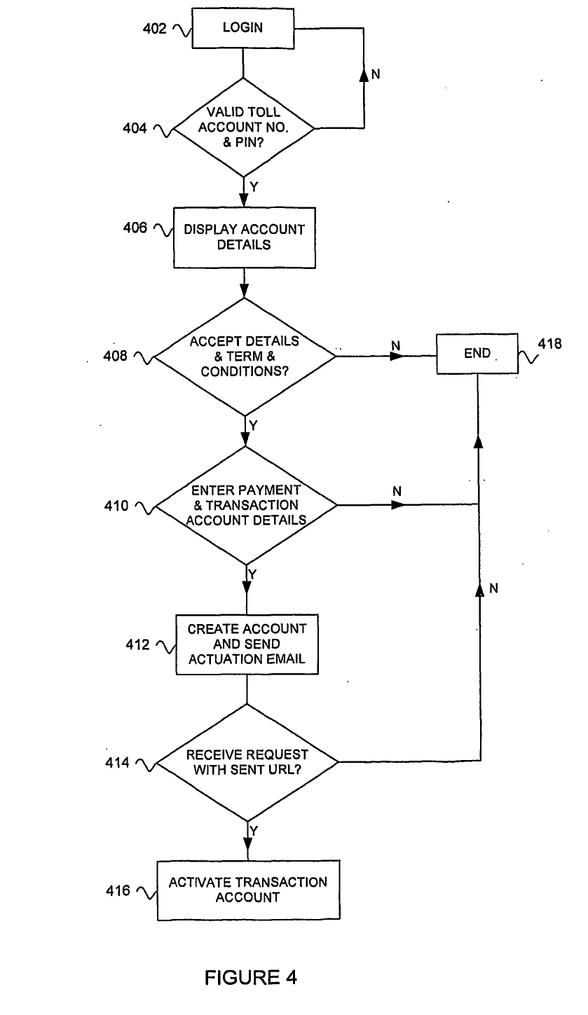

The transaction system is available for use by current holders of eTags 230 and tolling accounts. To use the system, a user needs to collect a freely distributed iTag 240 from a distribution outlet, such as a retail store, and then access the central system 104 to establish a transaction account associated with the iTag. The website 320 of the web server 120 can be accessed by a user's client system 132 and used to perform a transaction account establishment process, as shown in FIG. 4. The site 320, first sends a login page (step 402) requesting entry by the client 132 of the account number for the toll account and an associated personal identification number (PIN). The toll account number and the PIN submitted are passed to the database server 110 to retrieve toll account data for the toll account (identified by the number) from the tolling system 142. Based on the data returned, the website 320 determines if the entered number and PIN represent a valid toll account association and combination (step 404). For an invalid combination, the site 320 resends the login page (step 402). For a valid combination, the accessed toll account data returned is used to send a display of the toll account details for verification by the user (406). The toll account data represents the numbers of the eTags associated with the account, the vehicle registration numbers and vehicles associated with the eTags, and personal data, such as the name and address of the holder of the account. Together with the returned toll account details, a HTTP link is provided to access terms and conditions associated with use of the transaction system and holding of a transaction account. A HTTP link is also provided to accept the terms and conditions, and the process only proceeds once the accept link is activated to return the associated response to the web server 120 (step 408). On receiving the accept response, the web server 120 registers the acceptance with its copy of the toll account data and returns a dynamic page with fields for the entry of data for the new transaction account. The data includes:
(i) A field for an identification number of the iTag 240 that is printed on material distributed with the iTag or printed on the iTag itself. The database 112 maintained by the database server 110 includes tables associating the iTag numbers printed on every iTag distributed with the identification data transmitted by that iTag. The identification data represents a unique identification number for the transponder that may be different or the same as that printed on the iTag.
(ii) A unique username and password combination for the transaction account.
(iii) Personal data representing name, address and contact details for the user of the transaction account. This includes an email address and a mobile phone number that may be subsequently used by the messaging server 130.
(iv) Payment account data. This includes fields that represent and define a payment account that may be used by the PPS to complete a payment for goods or services. For credit card accounts, this includes a field for cardholder name, card number, card type and card expiry date.

Once the above data has been successfully submitted to the web server 120, the toll account data and the submitted data is sent to the database server 110 with a request to create and establish a transaction account (410). The transaction account data is stored in tables with fields for the toll account data, the submitted data and the respective unique identification data for the identified iTag and one or more eTags associated with the tolling account. A transaction account actuation email is then sent to the email address submitted by the user, using the email subsystem 302 (412). The actuation email is sent with a unique URL encoded with an identifier for the new transaction account. The email asks the recipient to select the URL in order to activate the transaction account. The web server 320 receives a HTTP request with the encoded URL (414), and this event is passed to the database server 110 so as to set a field in the database 112 to activate the transaction account (416). This ensures the transaction account is established in association with a valid email address for the user. The establishment process ends (418) if the terms and conditions are not accepted, the requested data is not received or the encoded URL is not returned.

Although the tolling account is associated with the transaction account, the manner in which the two are established and operated on ensures they are effectively two different accounts, one used for a tolling system 142, and the other to authorise a payment transaction for goods and services, as described below. The association provides dual factor authentication for the transaction authorisation processes. The transaction account establishment process allows the prior and free distribution of the iTags, and then subsequent association with a tolling account. A tolling account may have one or more transaction accounts associated with it, as well as one or more eTags associated with it. Only one iTag is associated with each transaction account, but the same payment account (eg credit card) may be associated with one or more transaction accounts.

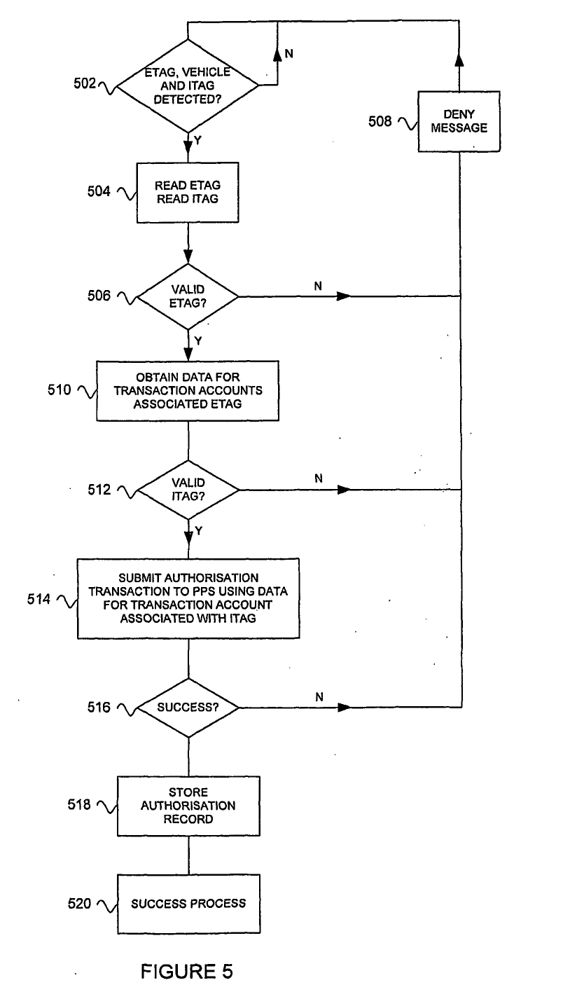

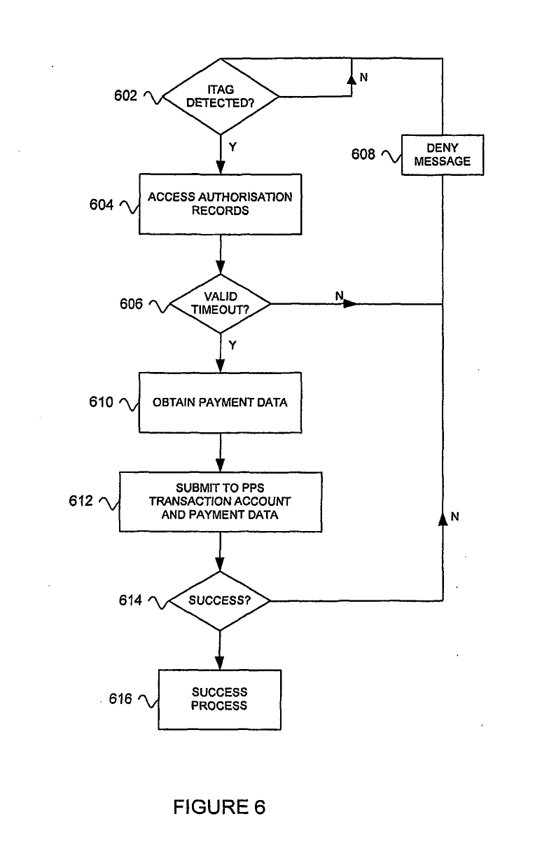

The entry system 106 performs an entry process, as shown in FIG. 5, and the payment system 108 performs a payment process, as shown in FIG. 6. Both submit selected fields of the transaction account data to the PPS 140, to obtain authorisation or approval, but neither transfers funds for payment. Payment is performed and handled by the PPS 140 using a payment account. The transaction system does not maintain the balance of a payment account. Accordingly, in addition to the dual factor authentication of the user, transaction authorisation is effectively performed twice by the transaction system.

The entry process, as shown in FIG. 5, commences, at step 502, by determining whether a vehicle 220, an eTag 230 and an iTag 240, have been detected. The iTag reader 212 reads the identification data of the iTag 240 and this is passed to and detected by a reader controller 330 of the local computer system 202. Once the iTag has been detected, the read identification data is passed to an entry controller 334 of the entry system 106 with a detection event. The entry controller 334 receives a similar detection event from an eTag reader controller 332 that communicates with the eTag reader 204. When a vehicle approaches an entry boom gate 204, its presence is detected by a vehicle presence relay (VPR) 216 in the road way. This VPR detection event is passed to the entry controller 334 of the local computer system 202 by the gate controller 206. Once the vehicle detection event, the iTag detection event and the eTag detection event have been received within a predetermined time of one another, the entry controller 334 proceeds to execute subsequent steps of the entry process.

The entry controller 334 and the reader controller 332 include modules written in computer program code, such as C++ or Java, or are implemented using dedicated hardware circuits. The controllers 332, 334 and the gate controller 206 include components of entry systems produced by Ski Data AG, Amano Cincinnati, Inc. or Data Park, Inc.

The entry controller 334 stores the read first identification data of the eTag and the second identification data of the iTag (504). The identification data for the eTag is passed to the database server 110 with a request to determine if the eTag is valid and whether any transaction accounts are associated with the eTag (506). The database server 110 communicates with the tolling system 142 to determine if the eTag is still valid and not listed on a blacklist of barred eTags. If the eTag is reported as valid, the database server retrieves the transaction account data of any transaction accounts associated with the eTag 230 and returns the transaction account data to the entry controller 334 (510). If the eTag is not valid, a deny message (508) is sent to the LCD 210 for display to the user of the iTag. The message advises that the iTag cannot be used to facilitate payment.

On obtaining data for the associated transaction accounts, the entry controller 334 uses the data to determine whether the read iTag is currently valid (step 512). This involves determining whether the second identification data is associated with one, of the transaction accounts retrieved for the eTag, and whether the iTag or the identified transaction account is the subject of a blacklist. If the iTag is determined to be invalid, then the deny message (508) is displayed, otherwise the payment account data of the identified transaction account is used to submit an authorisation transaction to the PPS 140. The authorisation transaction is a test transaction to obtain authorisation data for payment of a predetermined amount, say $50, using the payment account of the transaction account. If the PPS 140 returns authorisation data representing that the transaction is approved and can proceed, this effectively validates a payment account as being good for making a payment for a predetermined period of time. The successful authorisation is reported to the communications controller 310 and transmitted to the entry controller 334 in a success message (step 516). If the success message is not received within the predetermined time or it is reported that the payment account for the predetermined amount is not approved, the deny message (508) is sent for display on the LCD 210. If the success message is received, the entry controller 334, and the database server 110 store an authorisation record associated with the transaction account. The authorisation record includes data representing the authorisation transaction, and in particular the time at which an approval message was received from the PPS 140. The time of the authorisation record is the authorisation time. On storing the authorisation record (step 518), the entry controller 334 performs a success process (520). The success process involves:
(i) Sending a success message for display on the LCD 210. This success message advises the user that the iTag 240 can be used for attending to payment at the site for goods or services, including paying for parking at the site.
(ii) Sending an open message to the gate controller 206, which causes the gate controller to open the boom gate 214 to allow the vehicle 220 to enter a parking area within the site.

The user is able to use the iTag 240 to attend to payment of any ‘goods’ or services within the site by first placing the iTag within the proximity of an iTag reader 340 connected to a payment system 108 of the site. The payment system 108 is a local computer system that forms a payment terminal and includes a read controller 342 for the reader 340, and a payment controller 344. The payment controller 344 includes a module written in computer program code, such as C++ or Java, or implemented using dedicated hardware circuits, and can also include components of existing cash registers or Point of Sale terminals. The read controller 342 and the iTag reader 340 are the same as those used by the entry system 106. Once the read controller 342 detects an iTag and reads the identification data of the iTag, a detection event with the data is passed to the payment controller 334 (602), as shown in FIG. 6. In response, the payment controller 334 communicates with the database server 110 to obtain the stored authorisation record for the transaction account associated with the iTag (604). The payment controller 344 processes the authorisation record obtained to determine (606) if (i) it is valid for the site and the location of the reader 340, and (ii) the detection event occurred within a predetermined time from the authorisation time. If the processing determines that the data meets the criteria (i) and (ii), then a message is sent and displayed on an LCD 346 of the payment system 102 requesting payment data to be entered. Otherwise a deny message is sent and displayed (608).

For certain locations of the tag reader 340, the payment controller 344 is able to generate the payment data itself. For example, if the tag reader 340 is located within an exit gate controller and the vehicle 220 is seeking to leave the site, then the payment controller 344 can determine, based on elapsed time, the amount that needs to be paid for the parking and generate payment data for that amount. The elapsed time is the difference between the authorisation time and the time of the iTag detection event at the payment controller 344. On receiving payment approval the exit controller can issue an open message to open an exit gate for the vehicle. In other circumstances, e.g. at a retail outlet, a person may need to enter the amount and any other details required using an input device 350, such as a keypad, of the payment terminal. The payment system 108 can also be incorporated within a payment or cash register of an outlet providing the goods or services. The payment data in addition to representing the amount may also represent other information, such as a description of the goods or services. Once the payment controller 344 has obtained the payment data, the payment controller 344 submits a transaction request to the PPS 140 (612). The transaction request includes the payment data and transaction account data that is required, such as the data representing the payment amount and the payment account of the transaction account. The transaction request includes the data necessary for the PPS 140 to attend to a funds transfer or payment for the goods or services associated with the payment data using the payment account. Success or failure of the transaction processed by the PPS 140 is reported back as approval data to the database server 110 and in turn to the payment controller 344. A success message is sent to the payment controller 344 if the payment transaction is approved by the PPS 140. If the success message is not received within a predetermined time (614), a deny message (608) is sent for display on the LCD 346. If the success message is received, the payment controller 344 performs a success process (616). The success process involves displaying a payment successful message on the LCD 346 and printing a receipt for the payment using a printer 348. The payment system 108 may only print the receipt if requested or by default.

The transaction system allows users to make a payment for goods or services at a site without documents needing to be signed or cash to be handled. Nor do credit cards need to be presented. All that is required is for a user to park at the site with a vehicle possessing a valid eTag, and once the iTag has been authorised on entry, they can use the iTag at various payment terminals to attend to payment. The security of the transaction system, despite the convenience of use, is enhanced by the dual factor authentication that is provided by using both the eTag and the iTag, and the system performs an authorisation process twice to authorise a payment transaction.

Many modifications will be apparent to those skilled in the art without departing from the scope of the present invention as herein described with reference to the accompanying drawings.

1. A transaction system, including:
an entry system for reading first identification data from a first device and second identification data from a second device; and
a database system for accessing payment account data of a transaction account on the basis of said first and second identification data, and requesting authorisation data for a payment transaction using said payment account data;
said entry system performing an authorisation process in response to said authorisation data being received.

2. A transaction system as claimed in claim 1, wherein said database system stores an authorisation record with an authorisation time in response to said authorisation data being received.

3. A transaction system as claimed in claim 1, wherein said database system validates said first device on receiving said first identification data and accesses transaction accounts associated with said first identification data.

4. A transaction system as claimed in claim 3, wherein said database system validates said second device on receiving said second identification data and determines the transaction account associated with said second identification data.

5. A transaction system as claimed in claim 1, wherein said authorisation process includes advising of authorisation of use of said second device for attending to a payment.

6. A transaction system as claimed in claim 5, wherein said authorisation process includes generating a message to allow entry to a site.

7. A transaction system as claimed in claim 2, including a payment system for reading said second identification data from said second device and generating payment data representing a payment amount;
said database system determining authorisation for a payment transaction on the basis of said second identification data and said authorisation record, and in response submitting said payment data and said payment account data to a payment processing system for performing said payment transaction.

8. A transaction system as claimed in anyone of the preceding claims, wherein said first and second devices are RFID devices.

9. A transaction system as claimed in claim 8, wherein said first device is associated with a tolling account of a tolling system and is located in a vehicle.

10. A transaction process including:
reading first identification data from a first device and second identification data from a second device;
accessing a transaction account on the basis of said first and second identification data;
requesting authorisation data for a payment transaction using payment account data of said transaction account; and
storing an authorisation record with an authorisation time in response to said authorisation data being received.

11. A transaction process as claimed in claim 10, including validating said first and second devices using said first and second identification data.

12. A transaction process as claimed in claim 11, wherein said validating includes comparing said identification data against blacklist data for invalid devices.

13. A transaction process as claimed in claim 10, including accessing transaction accounts associated with said first identification data, and determining the transaction account of said transaction accounts that is associated with said second identification data.

14. A transaction process as claimed in claim 10, including advising of authorisation of use of said second device for attending to a payment, in response to receipt of said authorisation data.

15. A transaction process as claimed in claim 10, including generating a message to allow a user of the second device to enter a site, in response to receipt of said authorisation data.

16. A transaction process as claimed in claim 10 or 11, including:
reading said second identification data from said second device and generating payment data representing a payment amount;
determining authorisation for a payment transaction on the basis of said second identification data and said authorisation record, and
submitting said payment data and said payment account data to a payment processing system for performing said payment transaction.

17. A transaction process as claimed in any one of claims 10 to 16, wherein said first and second devices are RFID devices.

18. A transaction process as claimed in claim 17, wherein said first device is associated with the tolling account of a tolling system and is located in a vehicle.

19. A transaction process as claimed in claim 18, wherein said validating includes accessing said tolling account on the basis of said first identification data.

20. A transaction process as claimed in any one of claims 17 to 19, wherein said second device is a passive short range RFD device, and said first device is an active RFD device with a range of about 100 meters.

21. A transaction process, including:
reading and validating a first RFID;
reading and validating a second RFID;
accessing payment account data associated with said first RFID and said second RFID; and
submitting an authorisation transaction with said payment account data to a payment processing system to obtain authorisation data representing approval for subsequent use of said second RFID, within a predetermined period of time, to authorise a payment.

22. A transaction process as claimed in claim 13, including generating a message to allow entry to a site in response to said authorisation data.

23. A transaction process as claimed in claim 13, including:
reading said second RFID at a payment terminal;
accessing said authorisation record on the basis of said second identification data;
determining whether a payment transaction is authorised on the basis of said authorisation record; and
submitting said payment transaction with payment data representing a payment amount to a payment processing system.
